(19) United States
(12) Patent Application Publication
(10) Pub. No.: US 2024/0209687 A1
(43) Pub. Date: Jun. 27, 2024

(54) Internally Supported Bridging Apparatus for Connecting Tubular Frame Members

(71) Applicant: SECURE ORBIT INC., Thunder Bay (CA)

(72) Inventor: Tyler Bragnalo, Thunder Bay (CA)

(21) Appl. No.: 18/544,709

(22) Filed: Dec. 19, 2023

Related U.S. Application Data
(60) Provisional application No. 63/476,996, filed on Dec. 23, 2022.

(51) Int. Cl. E06B 11/02; E05D 15/06

(52) U.S. Cl. CPC E06B 11/026; E05D 15/0617; E05Y 2900/402

(57) ABSTRACT

A connecting device connects between the open ends of tubes of two adjacent frames within a cantilevered structure. The device is a bridging apparatus having opposing first and second portions received within the open ends of the tubes. First and second sets of circumferentially spaced fasteners bores in respective first and second portions of the bridging apparatus align with bores in the tubes so that fasteners threaded into the fastener bores clamp the first and second portions against corresponding inner surfaces of the tubes at each fastener location. In this manner, the fasteners in both tubes are oriented in different radial directions such that the bridging apparatus is better suited to bracing adjacent frame sections in a cantilevered structure such as a gate panel against a variety of different loads from different directions, including wind loads and the like.

This application claims the benefit under 35 U.S.C.119(e) of U.S. provisional application Ser. No. 63/476,996, filed Dec. 23, 2022.

### FIELD OF THE INVENTION

The present invention relates to a connecting device for connecting tubular frame members, and more particularly the present invention relates to a connecting device including a bridging apparatus that is internally received through the open ends of two tubular frame members being connected by the connecting device.

### BACKGROUND

Large gate openings within a perimeter fence are commonly enclosed by an elongate gate panel supported in a cantilevered manner from a track at one side of the gate opening. Because of the large size of the gate panel, it is desirable to form the gate panel in modular sections as described by Tymetal Corp. in U.S. Pat. No. 7,581,353. In this instance, top and bottom tubular frame members on adjacent modular sections of the gate panel are connected by bridging plates fastened within the interior of the tubular frame members. The bridging plates require all fasteners to be coupled to the tubular frame members within a common plane so that the connection between modular sections of the gate panel are not well suited to resist dynamic loads on the gate panel that may be applied from different directions such as from wind and the like.

### SUMMARY OF THE INVENTION

According to one aspect of the invention there is provided a connecting device for connecting a first frame having a first tubular frame member with an open end to a second frame having a second tubular frame member with an open end, the connecting device comprising:
a bridging apparatus extending in a longitudinal direction between a first end and a second end of the bridging apparatus so as to define (i) a first portion extending longitudinally between the first end and an intermediate location on the bridging apparatus and (ii) a second portion extending longitudinally between the intermediate location and the second end of bridging apparatus, the first and second portions of the bridging apparatus being sized and shaped to be received within the first and second tubular frame members respectively when the open ends of the first and second tubular frame members are abutted with one another in a mounted position;
a set of first fastener bores oriented radially within the first portion of the bridging apparatus for alignment with respective mounting apertures in the first tubular frame member in the mounted position, in which at least some of the first fasteners bores are circumferentially spaced apart from one another, the first fasteners bores being internally threaded so as to be arranged to receive first fasteners threaded therein from an exterior of the first tubular member to clamp the first portion of the bridging apparatus against an inner surface of the first tubular member at each first fastener location; and
a set of second fastener bores oriented radially within the second portion of the bridging apparatus for alignment with respective mounting apertures in the second tubular frame member in the mounted position, in which at least some of the second fasteners bores are circumferentially spaced apart from one another, the second fasteners bores being internally threaded so as to be arranged to receive second fasteners threaded therein from an exterior of the second tubular frame member to clamp the second portion of the bridging apparatus against an inner surface of the second tubular member at each second fastener location.

The use of fasteners which clamp the bridging apparatus to the interior of the tubular frame members at circumferentially spaced positions results in fasteners which are oriented in different radial directions relative to the tubular frame members such that the bridging apparatus is better suited to bracing adjacent frame sections in a gate panel against a variety of different loads from different directions, including wind loads and the like.

In preferred embodiments, the bridging apparatus includes a first body and a second body in which each of the first and second bodies spans longitudinally between the first end and the second end of the bridging apparatus, and in which each body including at least one first fastener bore and at least one second fastener bore therein. In this instance, the first body and the second body are preferably movable relative to one another to allow each body to be optimally clamped against corresponding portions of the inner surface of the tubular members for optimally aligning the tubular members relative to one another.

The bridging apparatus may further comprise a third body spanning longitudinally between the first end and the second end of the bridging apparatus, wherein the first body, the second body and the third body are arranged to engage an inner surface of the first and second tubular members at circumferentially spaced apart locations, and wherein the first body, the second body and the third body are movable relative to one another.

The device preferably further includes an expansion mechanism between the third body and the first and second bodies of the bridging apparatus, in which the expansion mechanism is operable to expand the third body radially outward relative to the first and second bodies to increase an overall circumference of the bridging apparatus within the first and second tubular frame members.

In some embodiments, the bridging apparatus further comprises (i) an intermediate body supported internally within the bridging apparatus so as to be surrounded by the first body, the second body and the third body, and (ii) a plurality of expansion screws operatively connected between the third body and the intermediate body so as to be arranged to expand the third body radially outward relative to the first and second bodies with the intermediate body engaged against the first and second bodies.

In the illustrated embodiment, the first tubular frame member and the second tubular frame member are circular in cross section, and the bridging apparatus has a polygonal boundary shape arranged to engage an inner surface of the first and second tubular members at a plurality of longitudinally extending edges which are circumferentially spaced apart from one another.

### BRIEF DESCRIPTION OF THE DRAWINGS

One embodiment of the invention will now be described in conjunction with the accompanying drawings in which:

FIG. 1 is a perspective view of a cantilevered sliding gate formed of modular panels that joined together by the connecting device according to the present invention;

2 is an enlarged view of the abutted ends of two tubular frame members of the sliding gate according to FIG. 1 in which the tubular frame members are connected by the connecting device according to the present invention;

FIG. 3 is a perspective view of the connecting device for connecting the two tubular members according to FIG. 1, in which one of the tubular frame members is removed for illustrative purposes;

FIG. 4 is another perspective view of the connecting device according to FIG. 3;

FIG. 5 is a perspective view of the connecting device removed from the tubular frame members, in which one of the members forming the connecting device has been removed for illustrative purposes;

FIG. 6 is a perspective view of the connecting device removed from the tubular frame members, in which two of the members forming the connecting device have been removed for illustrative purposes; and

FIG. 7 is a sectional view along the line 7-7 in FIG. 3. In the drawings like characters of reference indicate corresponding parts in the different figures.

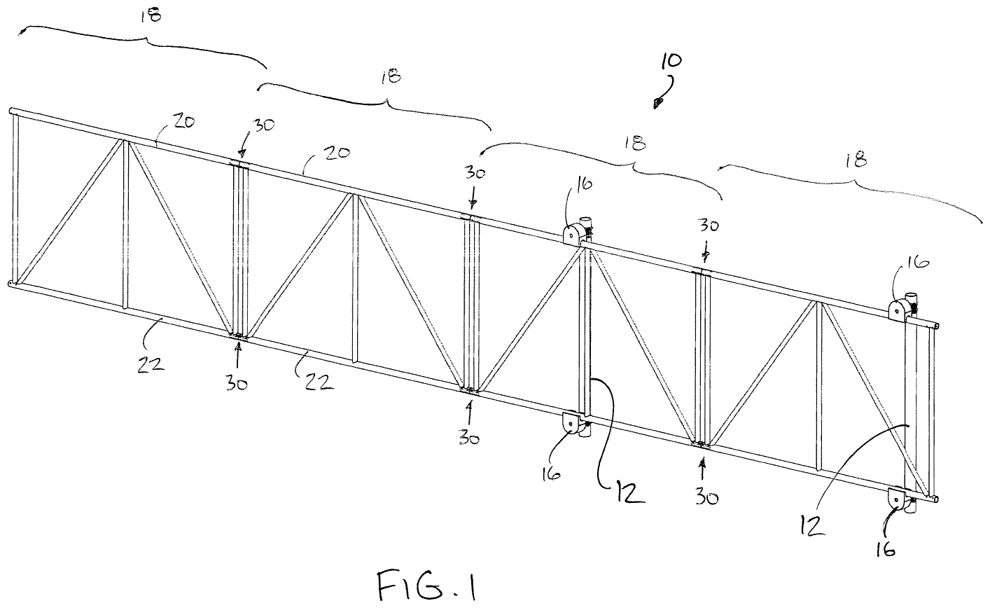

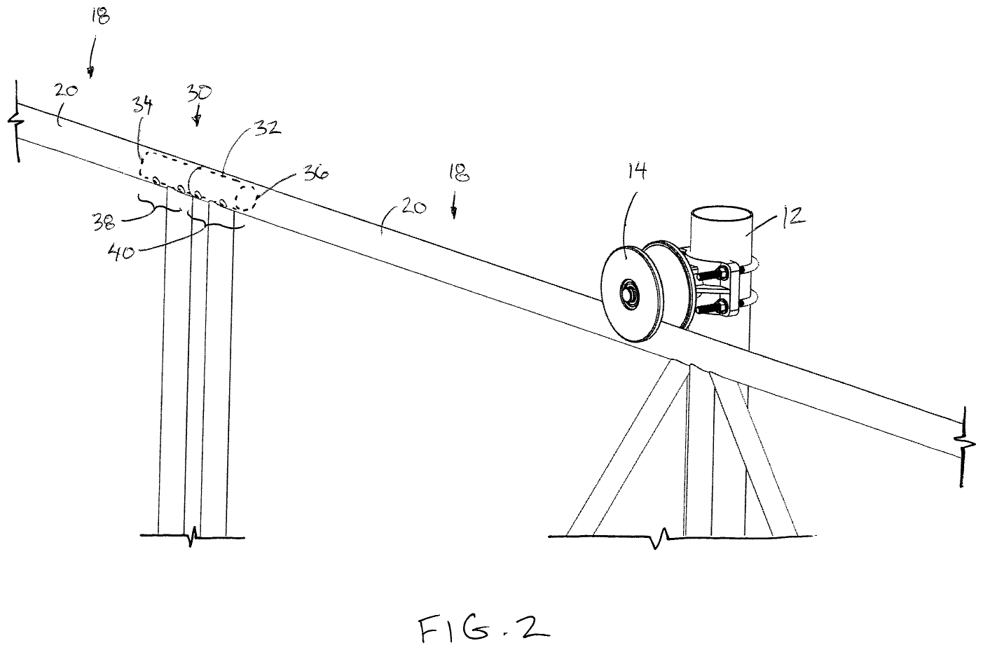

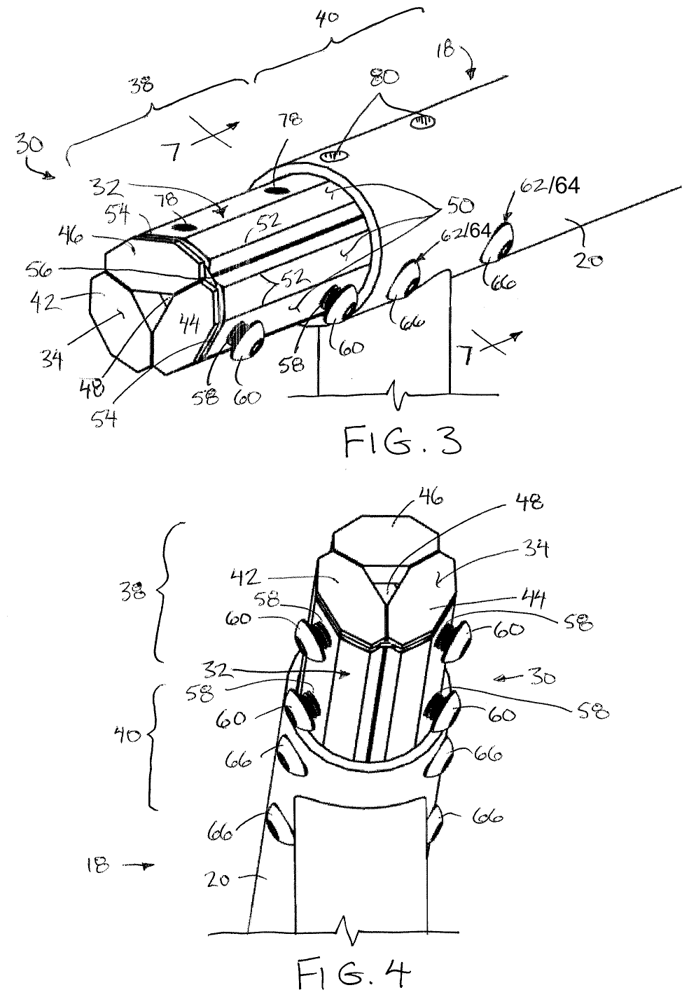

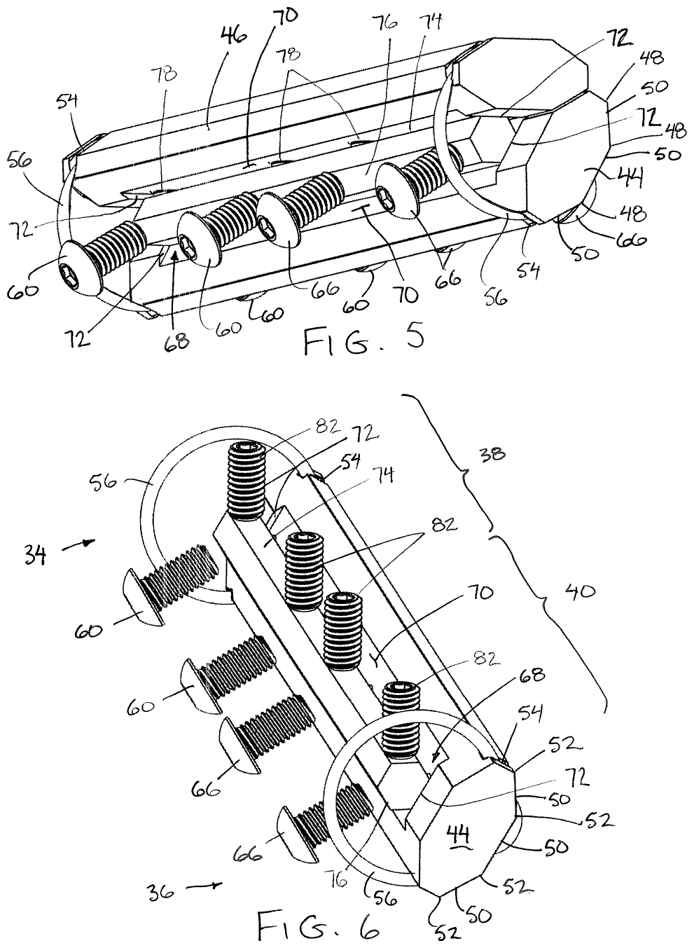

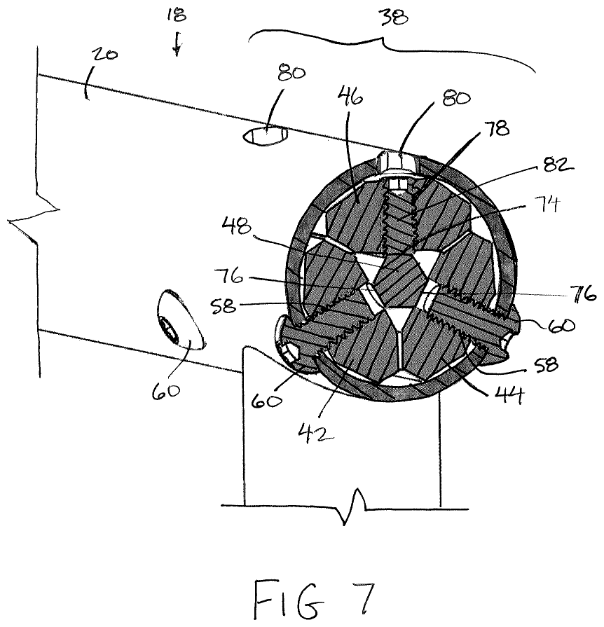

### DETAILED DESCRIPTION

Referring to the accompanying figures there is illustrated a gate panel generally indicated by reference numeral 10. The gate panel 10 is particularly suited for operation between open and closed positions relative to a gate opening in a perimeter fence in which the gate panel is supported for longitudinal sliding movement in the direction of the gate panel across the gate opening.

In the illustrated embodiment, the gate panel 10 is supported in a cantilevered manner in the longitudinal direction on a pair of support posts 12 which are longitudinally spaced apart at one side of the gate opening and which each carry top and bottom rollers 14 thereon for rolling engagement along top and bottom edges of the gate panel respectively. Each roller is partially covered within a respective roller housing 16. Each roller includes a concave recess extending circumferentially about the roller to define an annular groove receiving the corresponding top or bottom edge of the gate panel recessed therein. In the illustrated embodiment, the top and bottom edges of the gate panel are formed by round tube such that the concave profile of the rollers approximately matches the curvature of the top and bottom edges of the gate panel. T

he gate panel 10 in the figures is formed from a set of four identical modular frame sections 18 which are coupled end-to-end in a longitudinal row to occupy a generally common vertical plane of the gate panel. Each modular frame section 18 of the gate panel includes a top header 20 and a bottom footer 22 extending along the length of the frame section in the longitudinal direction of the gate panel at opposing top and bottom ends of the frames respectively.

Each of the top header 20 and the bottom footer 22 of each frame section is a tubular frame member having open ends. Each adjacent pair of the modular frame sections within the row are joined together such that the open ends of the tubular frame members at the top end and the bottom end of the frame sections are abutted with one another respectively. A connecting device 30 according to the present invention is received internally within the abutted open ends of each connected pair of tubular frame members of the gate panel. In the mounted position the tubular frame members across the tops of the frame sections are all aligned coaxially with one another and the tubular frame members across the bottoms of the frame sections are similarly aligned coaxially with one another.

Each connecting device 30 which is connected internally through the open ends of a connected pair of tubular frame members of the gate panel frame is generally comprised of (i) a bridging apparatus 32 partly received into each of the tubular frame members and (ii) a plurality of fasteners (described further below) threaded into the bridging apparatus through respective apertures communicating through the walls of the tubular frame members.

The bridging apparatus 32 is elongate in a longitudinal direction of the tubular frame members between opposing first and second ends 34 and 36 respectively. In a mounted position of the bridging apparatus within two connected tubular frame members 20 or 22, the bridging apparatus defines a first end portion 38 extending longitudinally between an intermediate central location on the apparatus and the first end 34 for being fully received within a first one of the tubular frame members, and a second end portion 40 extending longitudinally between the intermediate central location on the apparatus and the second and 36 for being fully received within a second one of the tubular frame members of a connected pair of frame members.

The bridging apparatus 32 is generally formed of a first body 42, a second body 44, and a third body 46 which are all identical to one another and which are positioned at circumferentially spaced positions about an intermediate body 48 extending longitudinally at the centre of the apparatus. Each of the first body 42, the second body 44, and the third body 46 extends longitudinally the full length of the apparatus between the first end 34 and the second end 36 thereof.

Each of the first body 42, the second body 44, and the third body 46 is generally polygonal in cross-sectional shape forming an eight-sided polygon at each of the opposing ends thereof. The shape of each body generally includes three outwardly facing exterior side surfaces 50 bound by four longitudinally extending exterior corner edges 52 of the body. When the three bodies 42, 44 and 46 are abutted with one another in the circumferential direction, each of the bodies includes four exterior edges 52 arranged for engagement with the inner surface of the round cross-section of the respective tubular member receiving the apparatus therein. The bodies are sized such that all four exterior corner edges approximately abut the cylindrical interior surface of the tubular members. When the apparatus is received within the tubular members, collectively the three bodies define a set of 12 exterior corner edges 52 forming contact with the interior surface of the tubular frame members at approximately evenly spaced circumferentially spaced positions.

Each of the bodies 42, 44 and 46 includes an end portion at both longitudinally opposing ends having a partial groove 54 formed therein such that the partial grooves at each end are aligned with one another about the full circumference of the apparatus to define a continuous annular groove that is arranged to receive a retainer ring 56 recessed into the groove at each of the two opposing ends of the apparatus. The retainer ring is a resilient O-ring arranged to be fully recessed into the partial grooves 54 to be recessed relative to the exterior surfaces of the apparatus. The retainer rings bias the bodies radially inward towards one another while allowing the bodies to be resiliently displaced radially outward relative to one another. In this manner, each of the bodies can be independently clamped securely against a respective portion of the inner surface of the tubular members independently of the other bodies to ensure all of the exterior corner edges of each body firmly engages the respective portion of the interior surface of the tubular members to maximize the alignment of the connected tubular members by the apparatus.

The first body 42 and the second body 44 are clamped against the interior surface of the tubular members by externally applied fasteners received within respective fastener bores formed within the bodies respectively. More particularly, the apparatus includes a plurality of first fastener bores 58 formed in the first end portion 38 of both the first body 42 and the second body 44 so as to receive first fasteners 60 threaded into the internally threaded first fastener bores 58 when inserted through cooperating mounting apertures 62 communicating through the walls of the tubular frame members in alignment with the first fastener bores 58 respectively. The apparatus also includes a plurality of second fastener bores 64 formed in the second end portion 40 of both the first body 42 and the second body 44 so as to receive second fasteners 66 threaded into the internally threaded second fastener bores 64 respectively when the fasteners are inserted through the cooperating mounting apertures 62 in the walls of the tubular frame members.

Within the first body 42, a first row of fastener bores receiving first fasteners therein is provided in which the fastener bores are spaced apart along a common first longitudinal axis that is parallel to the longitudinal direction of the apparatus. The first row of fastener bores within the first body 42 includes two of the first fastener bores 58 spaced longitudinally apart in the first portion 38 of the first body and two of the second fastener bores 64 spaced longitudinally apart in the second portion 40 of the first body. All of the fastener bores within the first row have respective axes which are located within a first fastener plane extending radially outward from a central axis of the apparatus.

Likewise, within the second body 44, a second row of fastener bores receiving second fasteners therein is provided in which the fastener bores are spaced apart along a common second longitudinal axis that is parallel to the longitudinal direction of the apparatus and that is spaced circumferentially apart from the first longitudinal axis. The second row of fastener bores within the second body 44 includes two of the first fastener bores 58 spaced longitudinally apart in the first portion 38 of the second body and two of the second fastener bores 64 spaced longitudinally apart in the second portion 40 of the second body. All of the fastener bores within the second row have respective axes which are located within a second fastener plane extending radially outward from the central axis of the apparatus.

In the illustrated embodiment the frame sections of the gate panel are generally planar with the tubular frame members connected by the bridging apparatuses being located at the top and bottom ends of the frame sections. The bridging apparatus is located so that the first and second bodies 42 and 44 are located at the innermost side of the tubular frame members towards the interior of the frame. The first and second fastener planes described above are oriented to be offset equally in the circumferential direction from opposing sides of the common plane of the gate panel. More particularly, when bisecting the tubular frame members 20 longitudinally with a bisecting plane perpendicular to the common plane of the frame, all of the first and second fasteners 60 and 66 are situated on the innermost half of the bisected tubular frame member 20 such that the outermost half forming the outer top edge of the frame section and the outer bottom edge of the frame section are devoid of any protruding fastener heads.

Each of the first fasteners 60 and the second fasteners 66 is inserted through a respective mounting aperture 62 from the exterior side of the tubular frame members such that the fastener heads remain at the exterior and abut the exterior surface of the tubular frame members as the fasteners are tightened. The threaded shafts of the fasteners are threaded into the respective fastener bores 58 or 64 to effectively clamp the first body 42 and the second body 44 independently against respective portions of the inner surface of the tubular frame members. More particularly, the first and second bodies are clamped against the interior surface of the tubular frame members at symmetrical locations on laterally opposing sides of the common plane of the gate panel forming a symmetry plane between the first and second bodies.

The mounting apertures 62 are formed in the tubular frame members using a suitable jig to precisely locate the mounting apertures for alignment with the corresponding fastener bores 58 or 64 when the associated pair of tubular frame members are abutted with one another in the mounted position.

Each of the first body 42, the second body 44, and the third body 46 includes a recessed cavity 68 along the radially innermost side of the body so as to define a flat inner surface 70 extending longitudinally along most of the length of the body between the longitudinally opposing end portions of the bodies so that the flat inner surfaces 70 lie perpendicularly to respective radial axes of the apparatus. In the mounted position, the inner surfaces 70 of the three bodies are oriented in a triangular pattern relative to one another surrounding the intermediate body 48 at the centre of the apparatus.

At the junction of the recessed cavity 68 and each end portion within each of the bodies 42, 44 and 46, the end portions each define a shoulder surface 72 lying perpendicularly to the longitudinal direction. In this manner, two opposing shoulder surfaces 72 protrude radially inward beyond the flat inner surface 70 at both ends of the inner surface 70 of the body. The longitudinally opposed shoulders 72 at the inner side of each of the bodies 42, 44 and 46 are spaced apart in the longitudinal direction by the length of the intermediate body 48 which is partly recessed into the cavity 68 of each of the bodies 42, 44 and 46. In this manner, the intermediate body 48 has opposing ends surfaces which define shoulders perpendicular to the longitudinal direction so that the intermediate body 48 is retained in the longitudinal direction by the ends surfaces engaging the two opposing shoulder surfaces 72 at opposing ends of each of the bodies 42, 44 and 46, whereby all of the bodies 42, 44 and 46 are effectively retained longitudinally relative to one another by their engagement with the intermediate body 48.

The intermediate body 48 has a generally hexagonal cross-sectional shape. An outermost face 74 of the intermediate body in proximity to the inner side 70 of the third body 46 lies approximately perpendicularly to a radial axis of the apparatus. At the opposing interior side of the intermediate body, the hexagonal shape of the intermediate body defines two mating surfaces 76 which taper inwardly towards one another as they extend away from the outermost face 74 at the third body 46 such that the mating faces 76 are oriented and positioned to lie against the inner surfaces 70 of the first body 42 and the second body 44 respectively.

In the mounted position, the third body 46 is positioned within the tubular frame members 20 to be located at the outermost portion nearest to the outer edge of the corresponding frame section of the gate panel. The third body includes a corresponding third row of fastener bores 78 formed therein which includes two fastener bores longitudinally spaced apart in the first end portion 38 of the apparatus and two fastener bores longitudinally spaced apart in the second end portion 40 of the apparatus. The axes of the threaded bores 78 in the third row lie in a common plane which is parallel to the plane of the frame sections and which forms a plane of symmetry between the first body 42 and the second body 44 of the apparatus. The plane of the threaded bores 78 extends generally radially outward from the central axis of the apparatus at evenly spaced apart positions in the circumferential direction relative to the first and second fastener planes described above.

The third fastener bores 78 in the third body are each located for alignment with a corresponding access hole 80 at the exterior side of the tubular members. Each threaded bore 78 receives a third fastener 82 defining an expansion screw of an expansion mechanism serving to expand the third body radially outward from the opposing first and second bodies at the interior side of the tubular frame members. Each of the third fasteners 82 is an externally threaded shaft with no head at the outer end so that a tool must be mated with an internal socket at the outer end of the fastener to drive rotation of the fastener. The fasteners 82 are intended to be fully recessed relative to the exterior of the tubular members and are also fully recessed into the third body at the outer end thereof.

The third fasteners 82 are threaded into the threaded bores 78 to protrude radially inward beyond the inner surface 70 at the interior side of the third body so that the inner ends of the fasteners 82 engage the outermost face 74 of the intermediate body within the interior of the apparatus. Tightening the third fasteners 82 causes the fasteners to protrude further into the interior of the apparatus which in turn urges the third body radially outward relative to the intermediate body 48 which is in turn engaged upon the first body 42 and the second body 44.

The sloped mating faces 76 at the interior side of the intermediate body engage the corresponding inner surfaces 70 of the first body 42 and the second body 44 to function as a wedge which further increases the radially outward clamping force of the first and second bodies engaged against the corresponding portions of the interior surface of the tubular frame members within which the apparatus is received. In this manner, tightening the third fasteners 82 (which define the expansion screws of the expansion mechanism described above) functions to simultaneously urge all three bodies 42, 44 and 46 radially outward into respective engagement with the inner surface of the tubular frame members.

The outer surface of the third body 46 is similarly shaped to the first and second bodies so as to define longitudinally extending corner edges 52 at the boundaries of exterior side surfaces 50 of the third body which serve to firmly engage with the inner surface of the tubular frame members being coupled.

In order to connect two adjacent frame sections, the top tubular frame members 20 and the bottom tubular frame members 22 of the adjacent frame sections are prepared by forming the mounting apertures 62 and the access holes 80 within the tubular frame members at the appropriate locations for alignment with the various fasteners described herein. One bridging apparatus 32 is inserted part way into each of the tubular frame members at the top connection and another bridging apparatus 32 is inserted part way into each of the tubular frame members at the bottom connection. Typically, only the fasteners associated with one of the first body or the second body are secured within one of the tubular frame members before the tubular frame members are brought together and abutted at their open ends with the bridging apparatus fully recessed into the interior of the tubular frame members. The remaining fasteners can then be inserted through the mounting apertures for threaded connection to each mounting location on the first and second bodies for tightly clamping the first and second bodies against the corresponding portions of the interior surface of the connected tubular frame members. As a final step, the third fasteners within the third body are tightened to fully expand the three bodies radially outward against respective portions of the inner surface of the tubular frame members to optimally align the tubular frame members connected by the bridging apparatus.

In some instance, use of the first and second bodies 42 and 44 without the third body 46 and the intermediate body 48 May be sufficient to provide adequate alignment and support between two connected frame sections.

In further embodiments, the first body 42, the second body 44, and the third body 46 May comprise different portions of a single unitary structure which are partly separated from one another by machined slots so that the bodies can remain resiliently expandable relative to one another similarly to the structure of a collet for example.

Since various modifications can be made in the invention as herein above described, and many apparently widely different embodiments of same made, it is intended that all matter contained in the accompanying specification shall be interpreted as illustrative only and not in a limiting sense.

1. A connecting device for connecting a first frame having a first tubular frame member with an open end to a second frame having a second tubular frame member with an open end, the connecting device comprising:
a bridging apparatus extending in a longitudinal direction between a first end and a second end of the bridging apparatus so as to define (i) a first portion extending longitudinally between the first end and an intermediate location on the bridging apparatus and (ii) a second portion extending longitudinally between the intermediate location and the second end of bridging apparatus, the first and second portions of the bridging apparatus being sized and shaped to be received within the first and second tubular frame members respectively when the open ends of the first and second tubular frame members are abutted with one another in a mounted position;
first fastener bores oriented radially within the first portion of the bridging apparatus for alignment with respective mounting apertures in the first tubular frame member in the mounted position, in which at least some of the first fasteners bores are circumferentially spaced apart from one another, the first fasteners bores being internally threaded so as to be arranged to receive first fasteners threaded therein from an exterior of the first tubular member to clamp the first portion of the bridging apparatus against an inner surface of the first tubular member at each first fastener location; and
second fastener bores oriented radially within the second portion of the bridging apparatus for alignment with respective mounting apertures in the second tubular frame member in the mounted position, in which at least some of the second fasteners bores are circumferentially spaced apart from one another, the second fasteners bores being internally threaded so as to be arranged to receive second fasteners threaded therein from an exterior of the second tubular frame member to clamp the second portion of the bridging apparatus against an inner surface of the second tubular member at each second fastener location.

2. The device according to claim 1 wherein at least some of the first fasteners bores are longitudinally spaced apart from one another, and at least some of the second fasteners bores are longitudinally spaced apart from one another.

3. The device according to claim 1 wherein the bridging apparatus includes a first body and a second body, each body spanning longitudinally between the first end and the second end of the bridging apparatus, and each body including at least one first fastener bore and at least one second fastener bore therein, the first body and the second body being movable relative to one another.

4. The device according to claim 3 wherein the first body and the second body are resiliently coupled to one another.

5. The device according to claim 3 wherein the first body and the second body are identical to one another.

6. The device according to claim 3 wherein the first body and the second body are coupled to one another by at least one retainer ring extending circumferentially about the bridging apparatus.

7. The device according to claim 6 said at least one retainer ring is received within a respective groove extending circumferentially about the bridging apparatus.

8. The device according to claim 6 wherein said at least one retainer ring comprises two retainer rings supported adjacent the first and second ends of the bridging apparatus respectively.

9. The device according to claim 3 wherein the bridging apparatus further comprises a third body spanning longitudinally between the first end and the second end of the bridging apparatus, wherein the first body, the second body and the third body are arranged to engage an inner surface of the first and second tubular members at circumferentially spaced apart locations, and wherein the first body, the second body and the third body are movable relative to one another.

10. The device according to claim 9 wherein the third body is identical to each of the first and second bodies of the bridging apparatus.

11. The device according to claim 9 further comprising an expansion mechanism between the third body and the first and second bodies of the bridging apparatus, the expansion mechanism being operable to expand the third body radially outward relative to the first and second bodies to increase an overall circumference of the bridging apparatus within the first and second tubular frame members.

12. The device according to claim 11 wherein the bridging apparatus further comprises (i) an intermediate body supported internally within the bridging apparatus so as to be surrounded by the first body, the second body and the third body, and (ii) a plurality of expansion screws operatively connected between the third body and the intermediate body so as to be arranged to expand the third body radially outward relative to the first and second bodies with the intermediate body engaged against the first and second bodies.

13. The device according to claim 12 wherein the intermediate body includes a pair of mating surfaces which are tapered towards one another as the mating surfaces extend away from the third body, and wherein the first and second bodies include sloped inner surfaces arranged to engage the mating surfaces respectively such that the intermediate body acts as a wedge between the first and second bodies as the third body is expanded radially outwardly by the expansion mechanism.

14. The device according to claim 12 wherein the intermediate body is longitudinally retained relative to at least one of the bodies by longitudinally opposing shoulders on said at least one of the bodies engaging corresponding surfaces on the intermediate body.

15. The device according to claim 12 wherein each of the first body, the second body and the third body includes longitudinally opposing shoulders engaging opposing end surfaces on the intermediate body to longitudinally retain each of the bodies relative to the intermediate body.

16. The device according to claim 1 wherein at least one of the first fasteners bores is aligned with at least one of the second fasteners bores along a first longitudinal axis and wherein at least one of the first fasteners bores is aligned with at least one of the second fasteners bores along a second longitudinal axis spaced circumferentially from the first longitudinal axis.

17. The device according to claim 16 wherein the first frame and the second frame generally lie in a common longitudinal plane bisecting each of the first tubular frame member and the second tubular frame member, and wherein the first longitudinal axis and the second longitudinal axis are equally spaced from the common longitudinal plane on opposing sides of the common longitudinal plane.

18. The device according to claim 1 wherein the first tubular frame member defines a header at one end of the first frame and the second tubular frame member defines a header at one end of the second frame, the first and second fasteners bores being aligned with the mounting apertures along an interior half of the first and second tubular frame members respectively.

19. The device according to claim 1 wherein the first frame comprises two first tubular frame members at opposing top and bottom ends of the first frame and the second frame comprises two second tubular frame members at opposing top and bottom ends of the second frame, the bridging apparatus being connected between the first tubular frame member and the second tubular frame member at the top ends of the frames, and the device further comprising a second apparatus identical in configuration to the bridging apparatus, the second apparatus being connected between the first tubular frame member and the second tubular frame member at the bottom ends of the frames.

20. The device according to claim 1 wherein the first tubular frame member and the second tubular frame member are circular in cross section, and wherein the bridging apparatus has a polygonal boundary shape arranged to engage an inner surface of the first and second tubular members at a plurality of longitudinally extending edges which are circumferentially spaced apart from one another.
